(19) United States
(12) Patent Application Publication
(10) Pub. No.: US 2025/0164231 A1
(43) Pub. Date: May 22, 2025

(54) DETECTING DEVICE

(71) Applicant: Japan Display Inc., Tokyo (JP)

(72) Inventor: Fumihoru NAKANO, Tokyo (JP)

(21) Appl. No.: 18/909,522

(22) Filed: Oct. 8, 2024

(30) Foreign Application Priority Data
Nov. 22, 2023 (JP) 2023-197869

(51) Int. Cl. G01B 7/293

(52) U.S. Cl. CPC G01B 7/293

(57) ABSTRACT

In a detecting device, a second strain gage element of a second strain gage and a third strain gage element of a third strain gage are arranged symmetrically from a position of a center in a thickness direction of a substrate, and are superposed on each other as viewed in plan. A first strain gage element of a first strain gage and a fourth strain gage element of a fourth strain gage are arranged symmetrically from the position of the center in the thickness direction of the substrate, and are superposed on each other as viewed in plan. As viewed in plan, the first strain gage element and the second strain gage element are shifted from each other in a length direction of the substrate. In addition, as viewed in plan, the third strain gage element and the fourth strain gage element are shifted from each other in the length direction of the substrate.

### CLAIM OF PRIORITY

The present application claims priority from Japanese Patent Application JP 2023-197869 filed on Nov. 22, 2023, the content of which is hereby incorporated by reference into this application.

### BACKGROUND OF THE INVENTION

### (1) Field of the Invention

The present disclosure relates to a detecting device.

### (2) Background Technology

There is a strain detecting device as a detecting device. A flexible film-shaped or sheet-shaped strain gage sensor is known as an example of the strain detecting device. The strain gage sensor includes strain gages (strain gage elements) provided so as to be aligned with each other on a surface of a band-shaped flexible sheet base material and a plurality of signal lines for passing current that passes through these strain gages. In addition, a plurality of strain gages are provided to the front and back sides of the sheet. The strain gages on the front surface side are arranged so as to be respectively opposed to the strain gages on the back surface side. A curved shape of a surface of a subject (measurement target) can be detected by wrapping the strain gage sensor around the subject having the curved surface, and detecting a change in resistance of each of the strain gages.

### PRIOR ART DOCUMENT

### Patent Documents

[Patent Document 1] Japanese Patent Laid-Open No. 2013-185966
[Patent Document 2] Japanese Patent Laid-Open No. 2013-96821

### SUMMARY OF THE INVENTION

It is an object of the present disclosure to provide a technology for enabling one detecting device to detect a curved shape of a surface of a measurement target with high accuracy even when the measurement target has a surface of a shape whose radius of curvature changes sharply.

According to the present disclosure, there is provided a detecting device including: a band-shaped flexible substrate; a first strain gage provided in the substrate, and including a plurality of first strain gage elements provided in a form of a row at predetermined intervals in a length direction of the substrate; a second strain gage provided in the substrate, and including a plurality of second strain gage elements provided in a form of a row at predetermined intervals in the length direction of the substrate; a third strain gage provided in the substrate, and including a plurality of third strain gage elements provided in a form of a row at predetermined intervals in the length direction of the substrate; a fourth strain gage provided in the substrate, and including a plurality of fourth strain gage elements provided in a form of a row at predetermined intervals in the length direction of the substrate; and a detecting circuit connected to each of the first to fourth strain gage elements, each of the first to fourth strain gages being disposed via an insulating layer in the substrate such that an extending direction of the first to fourth strain gages is along the length direction of the substrate, the first to fourth strain gages being laminated in this order in a thickness direction of the substrate such that the extending direction of the first to fourth strain gages is the same direction, the second strain gage elements and the third strain gage elements being arranged symmetrically from a position of a center in the thickness direction of the substrate, and being superposed on each other as viewed in plan, the first strain gage elements and the fourth strain gage elements being arranged symmetrically from the position of the center in the thickness direction of the substrate, and being superposed on each other as viewed in plan, the first strain gage elements and the second strain gage elements being shifted from each other in the length direction of the substrate as viewed in plan, the third strain gage elements and the fourth strain gage elements being shifted from each other in the length direction of the substrate as viewed in plan.

### BRIEF DESCRIPTION OF THE DRAWINGS

FIG. 1 is a perspective view of a strain gage sensor device according to an embodiment;

FIG. 2 is a longitudinal sectional view of the strain gage sensor device according to the embodiment;

FIG. 3 is sectional views of the strain gage sensor device, the sectional views being taken along a line A-A and a line B-B in FIG. 2;

FIG. 4 is a longitudinal sectional view of a strain gage sensor device according to a modification;

FIG. 5 is a developed view schematically illustrating strain gages and wiring of a second sensor pattern and a third sensor pattern of the strain gage sensor device according to the embodiment;

FIG. 6 is a perspective view schematically illustrating a laminated structure of a first sensor pattern CDA and a second sensor pattern CDB of a first sensor sheet 20A;

FIG. 7 is a diagram of assistance in explaining a strain gage sensor device according to a modification;

FIG. 8 is a block diagram of a controller of the strain gage sensor device according to the embodiment;

FIG. 9 is a plan view illustrating the first to fourth sensor patterns of the strain gage sensor device and an analog front end of the controller in a developed manner, the plan view illustrating a scanning operation at a time of detection;

FIG. 10 is a diagram schematically illustrating a part of the strain gage sensor device according to the embodiment in a state of being installed on a surface of a subject;

FIG. 11 is a plan view illustrating the first to fourth sensor patterns of the strain gage sensor device according to the embodiment and the analog front end of the controller in a developed manner, the plan view illustrating a scanning operation at a time of detection; and

FIG. 12 is a diagram of assistance in explaining a curved surface form obtained by plotting a radius of curvature and curved surface coordinates calculated on the basis of the detection values of strain gages GA and GD and the detection values of strain gages GB and GC at the positions of a plurality of strain gages of the strain gage sensor device according to the embodiment.

### DETAILED DESCRIPTION OF THE PREFERRED EMBODIMENT

An embodiment of the present disclosure will hereinafter be described in detail with reference to the drawings.

It is to be noted that the present disclosure is a mere example, and that appropriate changes that could be easily conceived by those skilled in the art while the spirit of the present disclosure is maintained are to be naturally included in the scope of the present disclosure. In addition, the width, thickness, shape, and the like of parts in the drawings may be represented schematically as compared with actual forms in order to make the description clearer, but are a mere example and do not limit the interpretation of the present disclosure. In addition, in the present specification and each figure, elements similar to those described earlier with reference to aforementioned figures are identified by the same reference numerals, and detailed description thereof may be omitted as appropriate.

### Embodiment

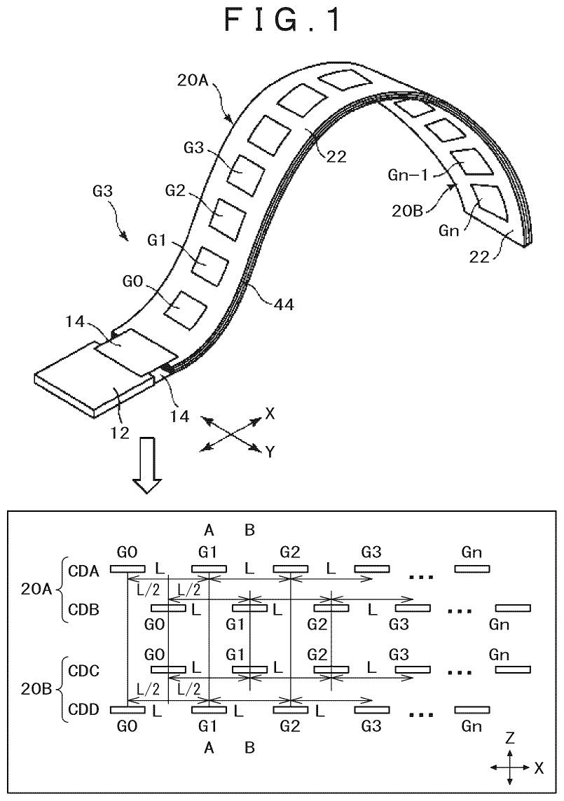

A strain gage sensor device 10 according to an embodiment will be described in detail as an example of a detecting device. FIG. 1 is a perspective view of the strain gage sensor device according to the embodiment.

As illustrated in FIG. 1, the strain gage sensor device 10 as the detecting device constitutes a strain gage sensor of a double-sided type. The strain gage sensor device 10 includes: an elongated band-shaped flexible base substrate 44 that functions as a base material; a first sensor sheet 20A affixed to a first principal surface (front surface) of the base substrate 44; a second sensor sheet 20B affixed to a second principal surface (back surface) of the base substrate 44; a pair of flexible wiring sheets (FPC) 14; and a relay substrate (driving circuit board) 12 connected to the first sensor sheet 20A and the second sensor sheet 20B via the pair of flexible wiring sheets 14. In an example, the base substrate 44 is an insulating layer, and is formed of a resin such as polyethylene terephthalate (PET) or polyimide with a thickness of approximately 0.3 to 0.5 mm.

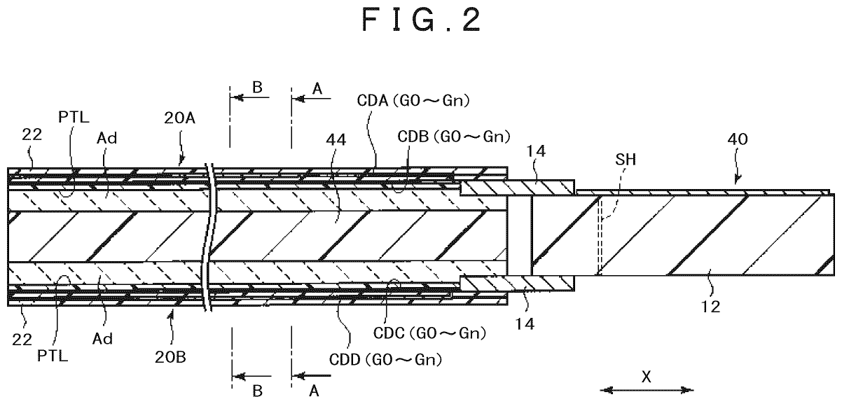

As illustrated in FIG. 2 to be described later, each of the first sensor sheet 20A and the second sensor sheet 20B includes an elongated band-shaped flexible sheet base material 22 formed of an insulating layer and conductor patterns (sensor patterns) CDA and CDB (CDC and CDD) in two layers provided to the sheet base material 22. The sensor pattern in each layer includes a plurality of strain gages G0 to Gn. The plurality of strain gages G0 to Gn are arranged so as to be aligned with each other in the form of a row in a longitudinal direction X at predetermined intervals from one end to another end in the longitudinal direction X of the sheet base material 22. The longitudinal direction X may be referred to as a length direction X. In addition, the base substrate 44 and the sheet base material 22 may be referred to collectively as a substrate (44 and 22).

Here, the strain gages G0 to Gn can be reworded as a plurality of strain gage element sheets G0 to Gn. The sensor patterns CDA, CDB, CDC, and CDD can be reworded as a first strain gage CDA, a second strain gage CDB, a third strain gage CDC, and a fourth strain gage CDD.

As illustrated in FIG. 1 as a schematic sectional view, the first sensor sheet 20A includes the first strain gage CDA and the second strain gage CDB, and the second sensor sheet 20B includes the third strain gage CDC and the fourth strain gage CDD. A plurality of first strain gage elements G0 to Gn of the first strain gage CDA are provided in the form of a row at predetermined intervals L in the length direction X of the base substrate 44 or the sheet base material 22. Similarly, a plurality of second strain gage elements G0 to Gn of the second strain gage CDB, a plurality of third strain gage elements G0 to Gn of the third strain gage CDC, and a plurality of fourth strain gage elements G0 to Gn of the fourth strain gage CDD are also provided in the form of a row at predetermined intervals L in the length direction X of the base substrate 44 or the sheet base material 22. In the present example, for each of the first to fourth strain gage elements G0 to Gn, the plurality of corresponding strain gage elements G0 to Gn are arranged at equal intervals (predetermined intervals L in this case) in the length direction X of the substrate. The predetermined intervals L can be reworded as arrangement intervals L.

Each of the first to fourth strain gages CDA to CDD is arranged on the base substrate 44 or the sheet base material 22 via an insulating layer such that the extending direction of the first to fourth strain gages CDA to CDD is along the length direction X of the substrate (44 and 22). Moreover, the first to fourth strain gages CDA, CDB, CDC, and CDD are laminated in this order in a thickness direction Z of the substrate (44 and 22) such that the extending directions (length direction X) of the first to fourth strain gages CDA to CDD are the same. The thickness direction Z will be explained with reference to FIG. 2 to be described later.

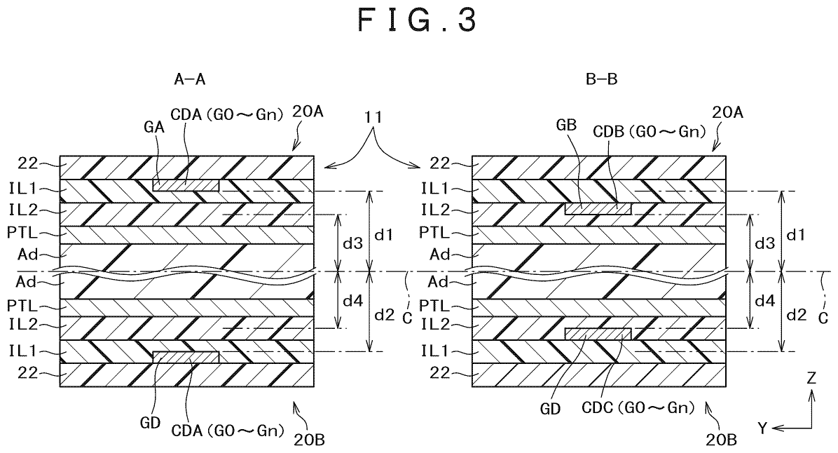

Moreover, the plurality of second strain gage elements G0 to Gn of the second strain gage CDB and the plurality of third strain gage elements G0 to Gn of the third strain gage CDC are arranged symmetrically from the position C (see FIG. 3) of a center in the thickness direction Z of the substrate (44 and 22), and are superposed on each other as viewed in plan. In addition, the plurality of first strain gage elements G0 to Gn of the first strain gage CDA and the plurality of fourth strain gage elements G0 to Gn of the fourth strain gage CDD are arranged symmetrically from the position C of the center in the thickness direction Z of the substrate (44 and 22), and are superposed on each other as viewed in plan.

In addition, as viewed in plan, the plurality of first strain gage elements G0 to Gn of the first strain gage CDA and the plurality of second strain gage elements G0 to Gn of the second strain gage CDB are arranged so as to be shifted from each other in the length direction X of the substrate (44 and 22). In addition, as viewed in plan, the plurality of third strain gage elements G0 to Gn of the third strain gage CDC and the plurality of fourth strain gage elements G0 to Gn of the fourth strain gage CDD are shifted from each other in the length direction X of the substrate (44 and 22). In the sectional view of FIG. 1, the plurality of first strain gage elements G0 to Gn of the first strain gage CDA and the plurality of second strain gage elements G0 to Gn of the second strain gage CDB are arranged so as to be shifted from each other by ½ of the arrangement interval L in the length direction X of the substrate (44 and 22). Similarly, the plurality of third strain gage elements G0 to Gn of the third strain gage CDC and the plurality of fourth strain gage elements G0 to Gn of the fourth strain gage CDD are arranged so as to be shifted from each other by ½ of the arrangement interval L in the length direction X of the substrate (44 and 22). That is, though an illustration of a plan view is omitted, the strain gage sensor device 10 can be regarded as one strain gage sensor device in which a plurality of gage elements are arranged in a row along the length direction X at arrangement intervals of L/2 as viewed in plan from a direction perpendicular to the top surface of the substrate (44 and 22). Thus, even in a case where a measurement target has a surface of a shape whose radius of curvature changes sharply, the shape of the top surface of an object as the measurement target can be identified accurately by the one strain gage sensor device 10 in which the arrangement intervals between the gage elements are reduced to L/2 as compared with the arrangement intervals L between the gage elements adjacent to each other.

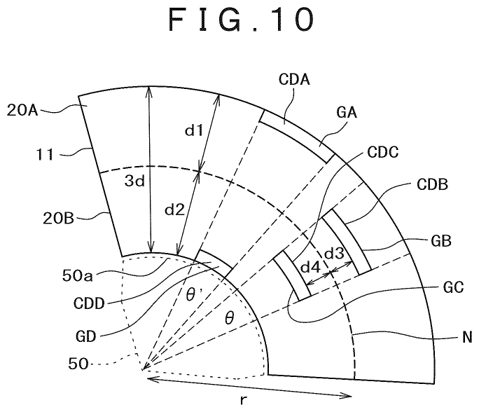

Incidentally, the position C will be explained with reference to FIG. 3 to be described later. In addition, the position C can also be regarded as the position of a neutral plane N, which will be explained with reference to FIG. 10 to be described later. In addition, in FIG. 1, the longitudinal direction X and a width direction Y of the sensor sheets represent two directions orthogonal to each other. These directions may intersect each other at an angle other than 90 degrees.

FIG. 2 is a longitudinal sectional view of the strain gage sensor device 10.

As illustrated in FIG. 2, the base substrate 44 has a front surface (or an upper surface) and a back surface (or a lower surface) opposed to the front surface. In an example, the first sensor sheet 20A is affixed to the front surface of the base substrate 44 by an adhesive layer Ad such as a transparent adhesive sheet (optically transparent adhesive; OCA: Optically Clear Adhesive). The second sensor sheet 20B is affixed to the back surface of the base substrate 44 by an adhesive layer Ad.

The relay substrate 12 includes a driving circuit 40 and a plurality of pieces of wiring provided on one surface side as well as a plurality of pieces of wiring not illustrated that are provided on another surface side. The first sensor pattern CDA and the second sensor pattern CDB of the first sensor sheet 20A are connected to the wiring provided on the upper surface side of the relay substrate 12 via the FPC 14. Similarly, the third sensor pattern CDC and the fourth sensor pattern CDD of the second sensor sheet 20B are connected to the wiring provided on the lower surface side of the relay substrate 12 via the FPC 14. The driving circuit 40 can be reworded as a detecting circuit.

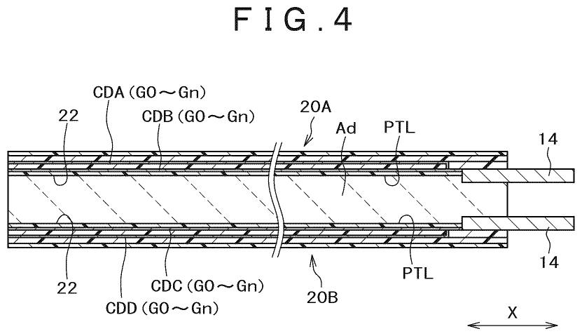

FIG. 3 is a lateral sectional view of the strain gage sensor device along a line A-A and a line B-B in FIG. 2. Incidentally, the line A-A and the line B-B in FIG. 2 correspond to a line A-A and a line B-B in the sectional view of FIG. 1. In FIG. 3, a sectional view along the line A-A is illustrated on a left side, and a sectional view along the line B-B is illustrated on a right side. FIG. 4 is a longitudinal sectional view of a strain gage sensor device according to a modification.

As illustrated in FIG. 3, the first sensor sheet 20A includes: the flexible band-shaped sheet base material 22; the first sensor pattern CDA (G0 to Gn) provided on one surface of the sheet base material 22; a first insulating layer IL1 laminated on the sheet base material 22 so as to be laid on the first sensor pattern CDA; the second sensor pattern CDB (G0 to Gn) provided on the first insulating layer IL1; a second insulating layer IL2 laminated on the first insulating layer IL1 so as to be laid on the second sensor pattern CDB; and a protective layer (surface protecting film) PTL provided on the second insulating layer IL2. In an example, the sheet base material 22 is formed of polyimide, and the first and second insulating layers IL1 and IL2 are formed of silicon nitride (SiN). In an example, the protective layer TPL side of the first sensor sheet 20A is bonded to the base substrate 44 by the adhesive layer Ad.

Similarly, the second sensor sheet 20B includes: the flexible band-shaped sheet base material 22; the fourth sensor pattern CDD provided on one surface of the sheet base material 22; a first insulating layer IL1 laminated on the sheet base material 22 so as to be laid on the fourth sensor pattern CDD; the third sensor pattern CDC provided on the first insulating layer IL1; a second insulating layer IL2 laminated on the first insulating layer IL1 so as to be laid on the third sensor pattern CDC; and a protective layer (surface protecting film) PTL provided on the second insulating layer IL2. In an example, the sheet base material 22 is formed of polyimide, and the first and second insulating layers IL1 and IL2 are formed of silicon nitride (SiN). In an example, the protective layer TPL side of the second sensor sheet 20B is bonded to the base substrate 44 by the adhesive layer Ad.

The whole of the base substrate 44, the adhesive layer Ad, the first sensor sheet 20A, and the second sensor sheet 20B will be referred to and described as a substrate 11. In addition, the strain gages (first strain gage elements G0 to Gn) of the first sensor pattern CDA will be referred to and described as first strain gages GA, the strain gages (second strain gage elements G0 to Gn) of the second sensor pattern CDB will be referred to and described as second strain gages GB, the strain gages (third strain gage elements G0 to Gn) of the third sensor pattern CDC will be referred to and described as third strain gages GC, and the strain gages (fourth strain gage elements G0 to Gn) of the fourth sensor pattern CDD will be referred to and described as fourth strain gages GD.

As illustrated in the sectional view along the line A-A on the left side of FIG. 3, a first strain gage GA and a fourth strain gage GD are arranged so as to be opposed to each other in the thickness direction Z of the substrate 11 with the insulating layers (IL1 and IL2), the protective layers TPL, the adhesive layers Ad, and the base substrate 44 interposed therebetween. In other words, the first strain gage GA and the fourth strain gage GD are arranged symmetrically from the position C of the center in the thickness direction Z of the substrate 11, and are superposed on each other as viewed in plan.

In addition, as illustrated in the sectional view along the line B-B on the right side of FIG. 3, a second strain gage GB and a third strain gage GC are arranged so as to be opposed to each other in the thickness direction Z of the substrate 11 with the insulating layers (IL1 and IL2), the protective layers TPL, the adhesive layers Ad, and the base substrate 44 interposed therebetween. In other words, the second strain gage GB and the third strain gage GC on the inside are arranged symmetrically from the position C of the center in the thickness direction Z of the substrate 11, and are superposed on each other as viewed in plan. When the position C of the center in the thickness direction Z of the substrate 11 is set as a center line C, the first strain gage GA and the fourth strain gage GD on the outside are arranged symmetrically with respect to the center line C, and the second strain gage GB and the third strain gage GC on the inside are arranged symmetrically with respect to the center line C.

That is, supposing that an interval between the first strain gage GA on the outside and the center line C is a first interval d1, that an interval between the fourth strain gage GD on the outside and the center line C is a second interval d2, that an interval between the second strain gage GB on the inside and the center line C is a third interval d3, and that an interval between the third strain gage GC on the inside and the center line C is a fourth interval d4, it is preferable that the first interval d1 and the second interval d2 be equal to each other (d1=d2) and that the third interval d3 and the fourth interval d4 be equal to each other (d3=d4). Settings may be made such that d1≠d3 and d2≠d4.

Incidentally, in the substrate 11, each of the first sensor sheet 20A and the second sensor sheet 20B may be configured such that the protective layer PTL side thereof is bonded to the base substrate 44 by the adhesive layer Ad. In addition, as illustrated in FIG. 4, a configuration may be adopted in which the base substrate 44 is omitted, and the first sensor sheet 20A and the second sensor sheet 20B are bonded to each other by an adhesive layer Ad such as a transparent adhesive sheet (OCA). The configuration of the strain gage sensor device 10 illustrated in FIG. 4 is the same as the configuration of the strain gage sensor device 10 illustrated in FIG. 2 except that the base substrate 44 is omitted. Thus, repeated description of the configuration of the strain gage sensor device 10 illustrated in FIG. 4 will be omitted.

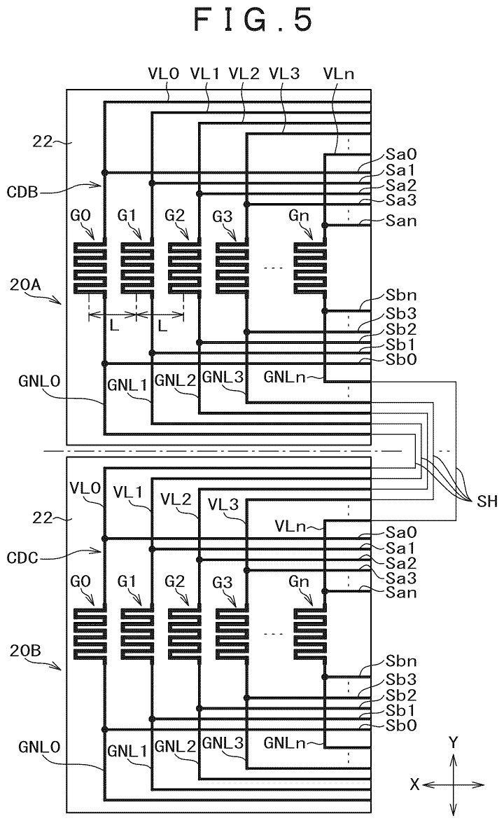

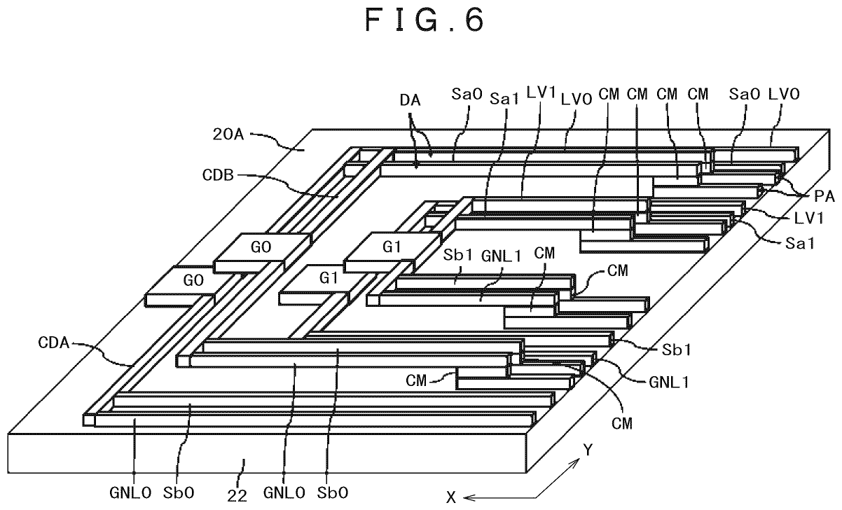

FIG. 5 is a developed view schematically illustrating the strain gages and wiring of the second sensor pattern CDB of the first sensor sheet 20A and the third sensor pattern CDC of the second sensor sheet 20B. FIG. 6 is a perspective view schematically illustrating a laminated structure of the first sensor pattern CDA and the second sensor pattern CDB in the first sensor sheet 20A.

As illustrated in FIG. 5, according to the present embodiment, the first sensor sheet 20A and the second sensor sheet 20B are configured to have the same shape, same dimensions, and the same sensor pattern. Description will be made of a pattern configuration representative of the second sensor pattern CDB of the first sensor sheet 20A and the third sensor pattern CDC of the second sensor sheet 20B. Each of the second sensor pattern CDB and the third sensor pattern CDC has a plurality of strain gages G0 to Gn. The plurality of strain gages G0 to Gn are provided so as to be aligned with each other in a row at intervals L in the longitudinal direction X from one end (distal end) to another end (proximal end) in the longitudinal direction X of the sheet base material 22. Each of the strain gages G0 to Gn extends in a bellows shape or a rectangular wave shape in the width direction Y, and has one end and another end in the width direction Y. Each of the strain gages G0 to Gn has a desired same resistance value in a state in which there is no strain in each of the strain gages G0 to Gn. In a state in which there is a strain in each of the strain gages G0 to Gn, the resistance value of each of the strain gages G0 to Gn changes according to the strain, and a resistance change thus occurs in each of the strain gages G0 to Gn. That is, the resistance value of the second strain gage element GB and the resistance value of the third strain gage element GC are configured to be the same in a state in which there is no strain, and the resistance value of the first strain gage element GA and the resistance value of the fourth strain gage element GD are configured to be the same in a state in which there is no strain. θn the other hand, the resistance value of the second strain gage element GB and the resistance value of the third strain gage element GC are configured to be different from each other in a state in which there is a strain, and the resistance value of the first strain gage element GA and the resistance value of the fourth strain gage element GD are configured to be different from each other in a state in which there is a strain.

The sensor patterns CDB and CDC each have a plurality of power supply lines VL0 to VLn, a plurality of ground lines GNL0 to GNLn, a plurality of first signal lines Sa0 to San, and a plurality of second signal lines Sb0 to Sbn each extending in the longitudinal direction X along the row of the strain gages G0 to Gn. The plurality of ground lines GNL0 to GNLn are connected such that a first reference potential such as a ground potential (GND: 0 V) is applied thereto. The plurality of power supply lines VL0 to VLn are connected such that a second reference potential (power supply potential) higher than the first reference potential is applied thereto.

The power supply lines VL0 to VLn are located on one end side of the strain gages G0 to Gn. The power supply lines VL0 to VLn respectively have one ends connected to the one ends of the strain gages G0 to Gn and other ends located on the proximal end side of the sheet base material 22. The power supply lines VL0 to VLn extend substantially in parallel with each other.

The first signal lines Sa0 to San are located between the one ends of the strain gages G0 to Gn and the power supply lines VL0 to VLn. The first signal lines Sa0 to San respectively have one ends connected to the one ends of the strain gages G0 to Gn and other ends located on the proximal end side of the sheet base material 22. The first signal lines Sa0 to San extend substantially in parallel with each other.

The ground lines GNL0 to GNLn are located on the other end side of the strain gages G0 to Gn. The ground lines GNL0 to GNLn respectively have one ends connected to the other ends of the strain gages G0 to Gn and other ends located on the proximal end side of the sheet base material 22. The ground lines GNL0 to GNLn extend substantially in parallel with each other.

The second signal lines Sb0 to Sbn are located between the other ends of the strain gages G0 to Gn and the ground lines GNL0 to GNLn. The second signal lines Sb0 to Sbn respectively have one ends connected to the other ends of the strain gages G0 to Gn and other ends located on the proximal end side of the sheet base material 22. The second signal lines Sb0 to Sbn extend substantially in parallel with each other.

As will be described later, in the present embodiment, the ground lines GNL0 to GNLn of the second sensor pattern CDB are respectively electrically connected, at the position of the relay substrate 12, to the power supply lines VL0 to VLn of the third sensor pattern CDC via a connecting metal within through holes SH. Thus, the strain gages of the second sensor pattern CDB are connected in series with the respective strain gages of the third sensor pattern.

In other words, a series connection is established between the second strain gage CDB and the third strain gage CDC such that one corresponding second strain gage element GB and one corresponding third strain gage element GC are connected in series with each other. One end of the series connection is connected to the first reference potential (for example, the ground potential: 0 V). Another end of the series connection is connected to the second reference potential (for example, the power supply potential: +nV) higher than the first reference potential. Similarly, a series connection is established between the first strain gage CDA and the fourth strain gage CDD such that one corresponding first strain gage element GA and one corresponding fourth strain gage element GD are connected in series with each other. One end of the series connection is connected to the first reference potential (for example, the ground potential: 0 V). Another end of the series connection is connected to the second reference potential (for example, the power supply potential: +nV).

As illustrated in FIG. 2 and FIG. 3, in the first sensor sheet 20A, the first sensor pattern CDA (G0 to Gn) is formed on the sheet base material 22, and the first insulating layer IL1 is laminated on the sheet base material 22 so as to be laid on the first sensor pattern CDA. The second sensor pattern CDB is formed on the first insulating layer IL1, and the second insulating layer IL2 is laminated on the first insulating layer IL1 so as to be laid on the second sensor pattern CDB.

As illustrated in FIG. 6, the strain gages G0 to Gn of the second sensor pattern CDB are respectively arranged so as to be shifted from the strain gages G0 to Gn of the first sensor pattern CDA by ½ of the arrangement interval L in the length direction of the first sensor sheet 20A (see also FIG. 1).

The power supply lines VL0 to VLn, the ground lines GNL0 to GNLn, the first signal lines Sa0 to San, and the second signal lines Sb0 to Sbn of the second sensor pattern CDB are respectively located so as to be slightly shifted in the width direction Y with respect to the power supply lines VL0 to VLn, the ground lines GNL0 to GNLn, the first signal lines Sa0 to San, and the second signal lines Sb0 to Sbn of the first sensor pattern CDA.

The power supply lines VL0 to VLn, the ground lines GNL0 to GNLn, the first signal lines Sa0 to San, and the second signal lines Sb0 to Sbn of the second sensor pattern CDB respectively have distal end side parts DA coupled to the strain gages G0 to Gn and proximal end side parts PA extending from intermediate portions to the proximal end of the sheet base material 22. The distal end side parts DA are provided on the first insulating layer IL1. The proximal end side parts PA are provided on the sheet base material 22. An end of each distal end side part DA is electrically connected to an end of the proximal end side part PA via connecting wiring CM formed within a contact hole provided in the first insulating layer IL1.

Thus, the proximal end side parts PA of the power supply lines VL0 to VLn, the ground lines GNL0 to GNLn, the first signal lines Sa0 to San, and the second signal lines Sb0 to Sbn of the second sensor pattern CDB are located in the same plane as the power supply lines VL0 to VLn, the ground lines GNL0 to GNLn, the first signal lines Sa0 to San, and the second signal lines Sb0 to Sbn of the first sensor pattern CDA, that is, located on the sheet base material 22, and are connected to wiring of the common FPC 14.

The third sensor pattern CDC and the fourth sensor pattern CDD of the second sensor sheet 20B are formed so as to have the same shape, the same dimensions, and the same structure as the first sensor pattern CDA and the second sensor pattern CDB of the first sensor sheet 20A illustrated in FIG. 6.

That is, as viewed in plan, the first strain gage elements G0 to Gn of the first strain gage CDA and the second strain gage elements G0 to Gn of the second strain gage CDB are shifted from each other in the length direction X of the substrate 11 (44 and 22). An amount of the shift in the present example is ½ of the arrangement interval L. In addition, similarly, as viewed in plan, the third strain gage elements G0 to Gn of the third strain gage CDC and the fourth strain gage elements G0 to Gn of the fourth strain gage CDD are shifted from each other in the length direction X of the substrate 11 (44 and 22). An amount of the shift in the present example is ½ of the arrangement interval L.

As illustrated in FIG. 2, the first sensor sheet 20A and the second sensor sheet 20B configured as described above are affixed to the front surface and the back surface of the base substrate 44, and are opposed to each other with the base substrate 44 interposed therebetween. That is, the first strain gage elements G0 to Gn of the first strain gage CDA of the first sensor sheet 20A are respectively opposed to the fourth strain gage elements G0 to Gn of the fourth strain gage CDD of the second sensor sheet 20B with the base substrate 44 interposed therebetween. The second strain gage elements G0 to Gn of the second strain gage CDB of the first sensor sheet 20A are respectively opposed to the third strain gage elements G0 to Gn of the third strain gage CDC of the second sensor sheet 20B with the base substrate 44 interposed therebetween.

Here, the first strain gage elements G0 to Gn of the first sensor sheet 20A and the fourth strain gage elements G0 to Gn of the second sensor sheet 20B preferably partly overlap each other as viewed in plan from a direction perpendicular to the top surface of the base substrate 44. In addition, the second strain gage elements G0 to Gn of the first sensor sheet 20A and the third strain gage elements G0 to Gn of the second sensor sheet 20B preferably partly overlap each other as viewed in plan from the direction perpendicular to the top surface of the base substrate 44. The first strain gage elements G0 to Gn of the first sensor sheet 20A and the fourth strain gage elements G0 to Gn of the second sensor sheet 20B preferably overlap each other without being shifted from each other in the width direction Y while allowed to be shifted from each other in the longitudinal direction X as viewed in plan from the direction perpendicular to the top surface of the base substrate 44. In addition, the second strain gage elements G0 to Gn of the first sensor sheet 20A and the third strain gage elements G0 to Gn of the second sensor sheet 20B preferably overlap each other without being shifted from each other in the width direction Y while allowed to be shifted from each other in the longitudinal direction X as viewed in plan from the direction perpendicular to the top surface of the base substrate 44. Alternatively, the first strain gage elements G0 to Gn of the first sensor sheet 20A and the fourth strain gage elements G0 to Gn of the second sensor sheet 20B more preferably overlap each other without being shifted from each other in the longitudinal direction X nor in the width direction Y as viewed in plan from the direction perpendicular to the top surface of the base substrate 44. In addition, the second strain gage elements G0 to Gn of the first sensor sheet 20A and the third strain gage elements G0 to Gn of the second sensor sheet 20B more preferably overlap each other without being shifted from each other in the longitudinal direction X nor in the width direction Y as viewed in plan from the direction perpendicular to the top surface of the base substrate 44.

The wiring of the first sensor pattern CDA and the second sensor pattern CDB of the first sensor sheet 20A extends onto the upper surface of the relay substrate 12 via the FPC 14. The wiring of the third sensor pattern CDC and the fourth sensor pattern CDD of the second sensor sheet 20B extends onto the back surface of the relay substrate 12 via the FPC 14. In the present embodiment, the ground lines GNL0 to GNLn of the first sensor pattern CDA are respectively electrically connected to the power supply lines VL0 to VLn of the fourth sensor pattern CDD by plated through holes SH as connection lines formed in the relay substrate 12. Further, the ground lines GNL0 to GNLn of the second sensor pattern CDB are respectively electrically connected to the power supply lines VL0 to VLn of the third sensor pattern CDC by plated through holes SH as connection lines formed in the relay substrate 12.

It is to be noted that the connection lines are not limited to the plated through holes SH, but a wiring pattern on the relay substrate 12 or the like may be used. In addition, a configuration can also be adopted in which the FPC 14 on the second sensor sheet 20B side is also connected to the upper surface side of the relay substrate 12, and thereby the ground lines GNL0 to GNLn of the first sensor sheet 20A are respectively connected to the power supply lines VL0 to VLn of the second sensor sheet 20B via wiring on the relay substrate 12 rather than the plated through holes. Further, a configuration can also be adopted in which the FPC 14 on the first sensor sheet 20A side and the FPC 14 on the second sensor sheet 20B side are connected to the driving circuit 40 provided on the upper surface side of the relay substrate 12, and the ground lines GNL0 to GNLn of the first sensor sheet 20A are respectively connected to the power supply lines VL0 to VLn of the second sensor sheet 20B within the driving circuit 40.

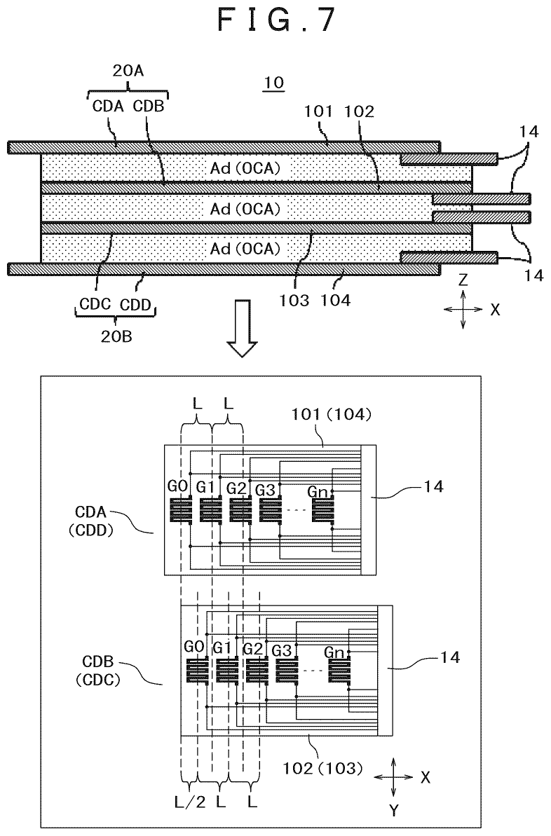

FIG. 7 is a diagram of assistance in explaining a strain gage sensor device 10 according to a modification. FIG. 7 depicts a schematic sectional view of the strain gage sensor device 10 and a diagram of assistance in explaining a concept of the modification. Incidentally, FIG. 7 does not depict the relay substrate 12 and the driving circuit 40 described with reference to FIG. 2 in order to simplify the drawing. However, as illustrated in FIG. 2, the relay substrate 12 and the driving circuit 40 are provided in actuality.

As illustrated on the upper side of FIG. 7, the strain gage sensor device 10 includes a first sensor substrate 101, a second sensor substrate 102, a third sensor substrate 103, a fourth sensor substrate 104, and adhesive layers Ad such as transparent adhesive sheets (OCA). The adhesive layers Ad are used to connect the first sensor substrate 101 and the second sensor substrate 102 to each other, connect the second sensor substrate 102 and the third sensor substrate 103 to each other, and connect the third sensor substrate 103 and the fourth sensor substrate 104 to each other. The whole of the first sensor substrate 101, the second sensor substrate 102, the third sensor substrate 103, the fourth sensor substrate 104, and the adhesive layers Ad can be regarded as an elongated band-shaped flexible substrate 11. The longitudinal direction X and the width direction Y of the substrate 11 are similar to those of FIG. 1. The longitudinal direction X and the width direction Y represent two directions orthogonal to each other. The directions X and Y may intersect each other at an angle other than 90 degrees.

A first strain gage CDA and an FPC 14 connected to the first strain gage CDA are arranged in or on the first sensor substrate 101. A second strain gage CDB and an FPC 14 connected to the second strain gage CDB are arranged in or on the second sensor substrate 102. A third strain gage CDC and an FPC 14 connected to the third strain gage CDC are arranged in or on the third sensor substrate 103. A fourth strain gage CDD and an FPC 14 connected to the fourth strain gage CDD are arranged in or on the fourth sensor substrate 104. Here, each of the first sensor substrate 101, the second sensor substrate 102, the third sensor substrate 103, and the fourth sensor substrate 104 can be said to be one bendable resistive sensor capable of measuring a curbed shape, which is fabricated by a sheet process and has the same shape, same dimensions, and the same configuration as the others.

As illustrated on the lower side of FIG. 7, a plurality of strain gages G0 to Gn of each of the first sensor substrate 101, the second sensor substrate 102, the third sensor substrate 103, and the fourth sensor substrate 104 are provided so as to be aligned with each other in a row at the arrangement intervals L in the longitudinal direction X from one end (distal end) to another end (proximal end) in the longitudinal direction X of the substrate 11.

Description will be made of a case where the strain gage sensor device 10 is assembled using the first sensor substrate 101, the second sensor substrate 102, the third sensor substrate 103, and the fourth sensor substrate 104. As illustrated on the lower side of FIG. 7, the first sensor substrate 101 and the second sensor substrate 102 are arranged so as to be shifted from each other in the length direction X of the substrate 11. Similarly, the third sensor substrate 103 and the fourth sensor substrate 104 are arranged so as to be shifted from each other in the length direction X of the substrate 11. In the present example, an amount of shift between the first sensor substrate 101 and the second sensor substrate 102 in the length direction X of the substrate 11, that is, an amount of shift between the first strain gage elements G1 to Gn of the first strain gage CDA and the second strain gage elements G0 to Gn of the second strain gage CDB as viewed in plan is set to be ½ of the arrangement interval L between strain gage elements adjacent to each other. An amount of shift between the third sensor substrate 103 and the fourth sensor substrate 104, that is, an amount of shift between the third strain gage elements G0 to Gn of the third strain gage CDC and the fourth strain gage elements G0 to Gn of the fourth strain gage CDD as viewed in plan is also set to be ½ of the arrangement interval L between strain gage elements adjacent to each other.

Thus, the first sensor substrate 101, the second sensor substrate 102, the third sensor substrate 103, and the fourth sensor substrate 104 are fabricated by fabricating a plurality of one kind of bendable resistive sensors capable of measuring a curbed shape. Then, the first sensor substrate 101, the second sensor substrate 102, the third sensor substrate 103, and the fourth sensor substrate 104 that have been fabricated are bonded to one another by using the adhesive layers Ad as in the following, for example.
(1) The first sensor substrate 101 and the second sensor substrate 102 are affixed to each other by using the adhesive layer Ad such that the first sensor substrate 101 and the second sensor substrate 102 are arranged so as to be shifted from each other by ½ of the arrangement interval L of the strain gage elements G0 to Gn in the length direction X of the substrate 11. The first sensor substrate 101 and the second sensor substrate 102 preferably coincide with each other in the width direction Y of the substrate 11.
(2) The third sensor substrate 103 and the fourth sensor substrate 104 are affixed to each other by using the adhesive layer Ad such that the third sensor substrate 103 and the fourth sensor substrate 104 are arranged so as to be shifted from each other by ½ of the arrangement interval L of the strain gage elements G0 to Gn in the length direction X of the substrate 11. The third sensor substrate 103 and the fourth sensor substrate 104 preferably coincide with each other in the width direction Y of the substrate 11.
(3) The second sensor substrate 102 and the third sensor substrate 103 are affixed to each other by using the adhesive layer Ad such that the first strain gage elements G0 to Gn of the first sensor substrate 101 and the fourth strain gage elements G0 to Gn of the fourth sensor substrate 104 are superposed on each other as viewed in plan and such that the second strain gage elements G0 to Gn of the second sensor substrate 102 and the third strain gage elements G0 to Gn of the third sensor substrate 103 are superposed on each other as viewed in plan.

Thus, a plurality of one kind of bendable resistive sensors capable of measuring a curbed shape are fabricated (plurality of identical sensor substrates are fabricated) by using the sheet process, and the lamination of these bendable resistive sensors capable of measuring a curbed shape is devised as in (1) to (3) described above. It is thereby possible to accurately measure the shape of the measurement target having a complex shape by using one strain gage sensor device 10 even when the measurement target has a shape whose radius of curvature changes sharply in some parts. It is consequently possible to improve reproducibility of the object shape of the measurement target. In addition, according to this configuration, it suffices only to design the one kind of bendable resistive sensors capable of measuring a curbed shape, and therefore the design cost of the bendable resistive sensors capable of measuring a curbed shape can be reduced. In addition, because it suffices to fabricate a plurality of one kind of bendable resistive sensors capable of measuring a curbed shape (identical sensor substrates), the work of fabricating the plurality of bendable resistive sensors capable of measuring a curbed shape can be performed relatively easily with a good yield. It is therefore possible to reduce the manufacturing cost of the bendable resistive sensors capable of measuring a curbed shape. Further, because one strain gage sensor device 10 can be fabricated by performing relatively easy alignment, the manufacturing cost of the strain gage sensor device 10 can be reduced. In addition, it becomes unnecessary to fabricate the strain gage sensor device 10 again according to an application for which the strain gage sensor device 10 is used (for example, according to the magnitude of the radius of curvature of the measurement target).

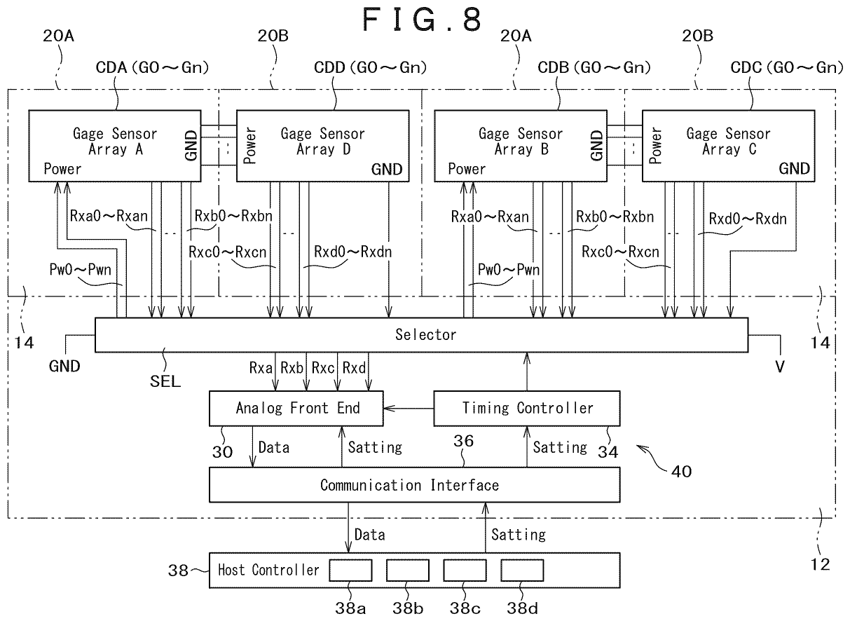

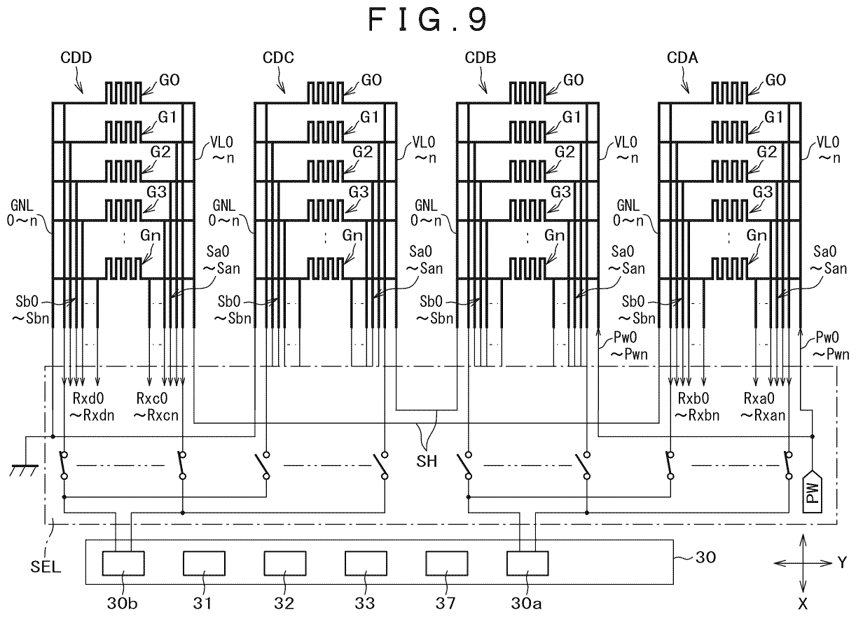

Description will next be made of the driving circuit 40 that drives the first sensor sheet 20A and the second sensor sheet 20B configured as described above. The driving circuit 40 may be referred to as a controller or a detecting circuit. FIG. 8 is a block diagram schematically illustrating the driving circuit of the strain gage sensor device 10. FIG. 9 is a plan view illustrating the first to fourth sensor patterns of the strain gage sensor device and an analog front end of the controller in a developed manner, the plan view illustrating a scanning operation at a time of detection. In addition, FIG. 9 is a block diagram illustrating the first to fourth sensor patterns and a selector and the analog front end of the controller. Incidentally, in FIG. 9, in order to simplify the drawing, the power supply lines VL0 to VLn of each sensor pattern are collectively represented as one power supply line, and the ground lines GNL0 to GNLn thereof are collectively represented as one ground line.

As illustrated in FIG. 8, the driving circuit 40 provided to the relay substrate (control circuit board) 12 includes a selector SEL, an analog front end (AFE: signal adjusting circuit) 30, a timing controller 34, a communication interface 36, and the like.

The communication interface 36 is connected to an external host controller 38 wirelessly or by wire. The communication interface 36 receives a driving signal (setting) from the host controller 38, and transmits detection data (Data) to the host controller 38.

The timing controller 34 outputs the driving signal to the selector SEL and the analog front end 30 in response to the driving signal (setting).

The selector SEL is constituted by a plurality of shift registers, a multiplexer, or the like. According to the driving signal from the timing controller 34, the selector SEL sequentially connects the power supply lines VL0 to VLn of the first and second sensor patterns CDA and CDB in the first sensor sheet 20A to a power supply, and thereby sequentially applies voltages Pw0 to Pwn to the strain gages G0 to Gn. In synchronism with this, the selector SEL sequentially reads detection signals (voltage values) Rxa0 to Rxan and Rxb0 to Rxbn on one end side and another end side of the respective strain gages G0 to Gn via the first signal lines Sa0 to San and the second signal lines Sb0 to Sbn.

The voltages Pw0 to Pwn supplied to the power supply lines VL0 to VLn of the first and second sensor patterns CDA and CDB are sequentially applied to the power supply lines VL0 to VLn of the third and fourth sensor patterns CDC and CDD via the ground lines GNL0 to GNLn and connection lines SH. In synchronism with the above-described reading, the selector SEL sequentially reads detection signals (voltage values) Rxc0 to Rxcn and Rxd0 to Rxdn on one end side and another end side of the respective strain gages G0 to Gn via the first signal lines Sa0 to San and the second signal lines Sb0 to Sbn of the third and fourth sensor patterns CDC and CDD in the second sensor sheet 20B.

As illustrated in FIG. 9, the analog front end 30 includes difference detecting circuits 30a and 30b, a readout circuit 31, an AD converter 32, a digital filter 33, a memory 37, and the like.

As illustrated in FIG. 9, according to the present embodiment, the analog front end 30 includes the difference detecting circuit (subtraction circuit) 30a for processing the detection signals of the first sensor sheet 20A and the difference detecting circuit (subtraction circuit) 30b for processing the detection signals of the second sensor sheet 20B. The analog front end 30 subjects the detection signals Rxa and Rxb and the detection signals Rxc and Rxd of the respective strain gages G0 to Gn sent from the selector SEL to signal adjustment (amplification, AD conversion, and filtering) according to the driving signal, and outputs resulting detection signals to the communication interface 36. At this time, because voltage drop values of the respective strain gages G are necessary for the calculation of the radius of curvature, the first and second difference detecting circuits 30a and 30b obtain differences between the detection values Rxa and Rxb of the respective strain gages G0 to Gn and differences between the detection values Rxc and Rxd of the respective strain gages G0 to Gn, and perform the signal output.

As illustrated in FIG. 8, the host controller 38 includes a reading circuit 38a, a memory 38b, an arithmetic processing unit 38c, a storage device 38d, and the like. The reading circuit 38a reads an output signal (difference data) sent from the communication interface 36, and stores the difference data in the memory 38b.

The arithmetic processing unit 38c, which is a central processing unit (CPU), for example, performs arithmetic processing such as data shaping and curved surface calculation on the basis of the difference data, and thereby calculates a strain (radius of curvature), a curved surface form (curved surface coordinates), and the like of a subject detected by the first and second sensor sheets 20A and 20B. The memory 38b stores the difference data, the calculated radius of curvature, the calculated curved surface form, a detection operation program, and the like. The storage device 38d is used as, for example, a work area of the CPU and the like.

Description will next be made of a detection operation mode of the strain gage sensor device 10.

FIG. 10 is a diagram schematically illustrating, partly on an enlarged scale, the strain gage sensor device 10 installed on a surface 50a of a subject 50. In an example, the subject 50 as a measurement target has the surface 50a that is curved in a wave shape or in a sine wave shape. The strain gage sensor device 10 is installed in close contact with the surface 50a of the subject 50, and detects the curved surface form of the subject 50. The shape of an object as the subject 50 can be thereby identified. In this case, the strain gage sensor device 10 is installed in a state in which the second sensor sheet 20B is in contact with the surface 50a of the subject 50. In addition, in an example, the respective sensor patterns of the first sensor sheet 20A and the second sensor sheet 20B are each assumed to include approximately four to eight strain gages G0 to Gn. An interval L between strain gages adjacent to each other is, for example, 5 to 20 mm, more preferably approximately 10 to 15 mm.

As illustrated in FIG. 10, suppose that the neutral plane N of the substrate 11 is curved with a radius of curvature r in a state in which the substrate 11 is installed on the surface 50a. Here, the neutral plane N is a plane in which neither expansion (tension) nor contraction (compression) occurs before and after the curving of the strain gage sensor device 10 (that is, a plane in which a strain is zero also after the curving). In the present embodiment, the neutral plane N is assumed to be located at the position C as the center (thickness x ½) in the thickness direction of the base substrate 44 (see FIG. 3).

The strain gage GA (which may be referred to as a first strain gage) of the first sensor pattern CDA in the first sensor sheet 20A, which first sensor pattern is located on an outer circumference side, and the strain gage GD (which may be referred to as a fourth strain gage) of the fourth sensor pattern CDD in the second sensor sheet 20B are opposed to each other in a radial direction (thickness direction Z) with insulating layers interposed therebetween. The strain gage GB (which may be referred to as a second strain gage) of the second sensor pattern CDB in the first sensor sheet 20A, which second sensor pattern is located on an inner circumferential side, and the strain gage GC (which may be referred to as a third strain gage) of the third sensor pattern CDC in the second sensor sheet 20B are opposed to each other in the radial direction (thickness direction Z) with insulating layers interposed therebetween. That is, among the four strain gages GA, GB, GC, and GD laminated in four layers, GA and GD are opposed to each other at an interval in the radial direction, and GB and GC are opposed to each other at an interval in the radial direction. The strain gage GA is located at an outermost circumference, the strain gage GD is located at an innermost circumference, and the strain gages GB and GC in two layers are located therebetween. Supposing that an interval d in the thickness direction Z between strain gages in two layers opposed to each other is fixed (the interval between GA and GB is d, the interval between GB and GC is d, and the interval between GC and GD is d), the thickness of the substrate 11 of the strain gage sensor device 10 is 3d. In a case where the neutral plane N is a flat plane, that is, in a state in which there is no strain in the second strain gage element GB and the third strain gage element GC and in the first strain gage element GA and the fourth strain gage element GD, the resistance value (initial resistance value: R0′) of the second strain gage element GB and the resistance value (initial resistance value: R0′) of the third strain gage element GC are configured to be the same. Similarly, the resistance value (initial resistance value: R0) of the first strain gage element GA and the resistance value (initial resistance value: R0) of the fourth strain gage element GD are configured to be the same. θn the other hand, in a state in which there is a strain in the second strain gage element GB and the third strain gage element GC and in the first strain gage element GA and the fourth strain gage element GD, the resistance value (R0′+ΔR0′ or R0′−ΔR0′) of the second strain gage element GB and the resistance value (R0′−ΔR0′ or R0′+ΔR0′) of the third strain gage element GC are configured to be different from each other. Similarly, the resistance value (R0+ΔR0 or R0-ΔR0) of the first strain gage element GA and the resistance value (R0-ΔR0 or R0+ΔR0) of the fourth strain gage element GD are configured to be different from each other. Here, +ΔR0 and +ΔR0′ denote an amount of change in the resistance value in a state in which the strain gage element is extended (or in an expanded state or a pulled state) in the longitudinal direction X, and −ΔR0 and −ΔR0′ denote an amount of change in the resistance value in a state in which the strain gage element is shrunk (or in a contracted state or a compressed state) in the longitudinal direction X.

Supposing that an interval between the strain gage GA at the outermost circumference and the neutral plane N is d1, that an interval between the strain gage GD at the innermost circumference and the neutral plane N is d2, that an interval between the intermediate strain gage GB and the neutral plane N is d3, and that an interval between the intermediate strain gage GC and the neutral plane N is d4, it is preferable that d1=d2 and d3=d4. Settings may be made such that d1≠d3 and d2≠d4.

In the detection operation mode, scanning driving of the power supply lines and the signal lines is performed, and thereby the strain gages G0 to Gn are driven sequentially and the detection values of the strain gages G0 to Gn are read sequentially. Specifically, at a time of detection, according to an instruction from the host controller 38, the timing controller 34 inputs a start signal and a clock signal synchronous with this start signal to the selector SEL, and thereby makes the strain gages G0 to Gn of the first and second sensor sheets 20A and 20B sequentially driven (setting) in one frame period.

As illustrated in FIG. 9, the selector SEL first applies a voltage to the two strain gages GA and GD located on the outside, and performs strain detection. The selector SEL drives the power supply line VL0 of the first sensor pattern CDA, that is, applies a power supply voltage to the power supply line VL0 to apply a desired voltage Pw0 to the strain gage G0. A current I is thereby passed through the strain gage G0 for a certain time. At the same time, the selector SEL obtains a detection signal (voltage value) Rxa0 at one end of the strain gage G0 and a detection signal (voltage value) Rxb0 at another end of the strain gage G0 via the first signal line Sa0 and the second signal line Sb0.

The ground line GNL0 of the first sensor pattern CDA is coupled to the power supply line VL0 of the fourth sensor pattern CDD of the second sensor sheet 20B. More specifically, the strain gage G0 (GA) of the first sensor pattern CDA and the strain gage G0 (GD) of the fourth sensor pattern CDD are connected in series with each other via the ground line GNL0 of the first sensor pattern CDA, the connection line (plated through hole) SH, and the power supply line VL0 of the fourth sensor pattern CDD. Therefore, when the strain gage G0 of the first sensor pattern CDA is driven, the strain gage G0 of the fourth sensor pattern CDD is driven synchronously, and the current I is passed also through the strain gage G0. At the same time, the selector SEL obtains a detection signal (voltage value) Rxc0 at one end of the strain gage G0 and a detection signal (voltage value) Rxd0 at another end of the strain gage G0 via the first signal line Sa0 and the second signal line Sb0 of the fourth sensor pattern CDD.

The obtained detection signals Rxa0, Rxb0, Rxc0, and Rxd0 are sent to the analog front end 30 to be subjected to difference detection for the detection values Rxa and Rxb and difference detection for the detection values Rxc and Rxd by the difference detecting circuits 30a and 30b, and then subjected to adjustment, and thereafter they are stored in the memory 37.

Next, the selector SEL drives the power supply line VL1 of the first sensor pattern CDA to apply a desired voltage Pw1 to each of the strain gage G1 of the first sensor pattern CDA and the strain gage G1 of the fourth sensor pattern CDD. The current I is thereby passed through the two strain gages G1 opposed to each other for a certain time. At the same time, the selector SEL obtains a detection signal Rxa1 at one end of the strain gage G1 and a detection signal Rxb1 at another end of the strain gage G1 via the first signal line Sal and the second signal line Sb1 of the first sensor pattern CDA. At the same time, the selector SEL obtains a detection signal Rxc1 at one end of the strain gage G1 and a detection signal Rxd1 at another end of the strain gage G1 via the first signal line Sal and the second signal line Sb1 of the fourth sensor pattern CDD.

The obtained detection signals Rxa1, Rxb1, Rxc1, and Rxd1 are sent to the analog front end 30 to be subjected to difference detection by the difference detecting circuits 30a and 30b, and then subjected to adjustment, and thereafter they are stored in the memory 37.

Thereafter, the selector SEL sequentially drives the strain gages G2 to Gn of the first sensor pattern CDA and the strain gages G2 to Gn of the fourth sensor pattern CDD, and sequentially obtains detection signals Rxa2 to Rxan, Rxb2 to Rxbn, Rxc2 to Rxcn, and Rxd2 to Rxdn of the strain gages G2 to Gn. The obtained detection signals are sequentially sent to the analog front end 30 to be subjected to difference detection and then adjustment, and thereafter they are stored in the memory 37.

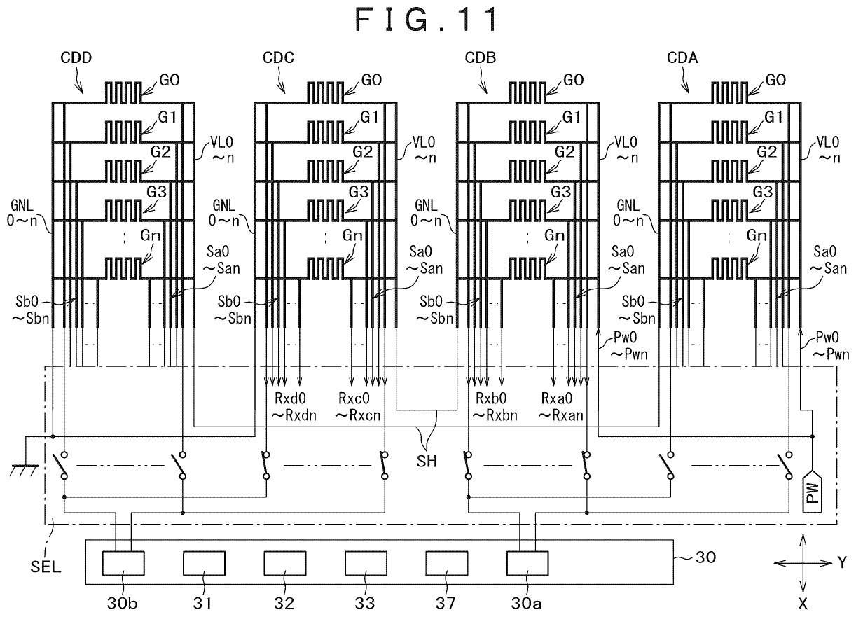

As illustrated in FIG. 11, next, the selector SEL applies a voltage to the two strain gages GB and GC located in intermediate layers (on the inside), and performs strain detection. Incidentally, in FIG. 11, in order to simplify the drawing, the power supply lines VL0 to VLn of each sensor pattern are collectively represented as one power supply line, and the ground lines GNL0 to GNLn thereof are collectively represented as one ground line.

Specifically, the selector SEL drives the power supply line VL0 of the second sensor pattern CDB of the first sensor sheet 20A to apply a desired voltage Pw0 to the strain gage G0. The current I is thereby passed through the strain gage G0 for a certain time. At the same time, the selector SEL obtains a detection signal (voltage value) Rxa0 at one end of the strain gage G0 and a detection signal (voltage value) Rxb0 at another end of the strain gage G0 via the first signal line Sa0 and the second signal line Sb0.

The ground line GNL0 of the second sensor pattern CDB is coupled to the power supply line VL0 of the third sensor pattern CDC of the second sensor sheet 20B. More specifically, the strain gage G0 (GB) of the second sensor pattern CDB and the strain gage G0 (GC) of the third sensor pattern CDC are connected in series with each other via the ground line GNL0 of the second sensor pattern CDB, the connection line (plated through hole) SH, and the power supply line VL0 of the third sensor pattern CDC. Therefore, when the strain gage G0 of the second sensor pattern CDB is driven, the strain gage G0 of the third sensor pattern CDC is driven synchronously, and the current I is passed also through the strain gage G0. At the same time, the selector SEL obtains a detection signal (voltage value) Rxc0 at one end of the strain gage G0 and a detection signal (voltage value) Rxd0 at another end of the strain gage G0 via the first signal line Sa0 and the second signal line Sb0 of the third sensor pattern CDC.

The obtained detection signals Rxa0, Rxb0, Rxc0, and Rxd0 are sent to the analog front end 30 to be subjected to difference detection for the detection values Rxa and Rxb and difference detection for the detection values Rxc and Rxd by the difference detecting circuits 30a and 30b, and then subjected to adjustment, and thereafter they are stored in the memory 37.

Next, the selector SEL drives the power supply line VL1 of the second sensor pattern CDB to apply a desired voltage Pw1 to each of the strain gage G1 of the second sensor pattern CDB and the strain gage G1 of the third sensor pattern CDC. The current I is thereby passed through the two strain gages G1 opposed to each other for a certain time. At the same time, the selector SEL obtains a detection signal Rxa1 at one end of the strain gage G1 and a detection signal Rxb1 at another end of the strain gage G1 via the first signal line Sal and the second signal line Sb1 of the second sensor pattern CDB. At the same time, the selector SEL obtains a detection signal Rxc1 at one end of the strain gage G1 and a detection signal Rxd1 at another end of the strain gage G1 via the first signal line Sal and the second signal line Sb1 of the third sensor pattern CDC.

The obtained detection signals Rxa1, Rxb1, Rxc1, and Rxd1 are sent to the analog front end 30 to be subjected to difference detection by the difference detecting circuits 30a and 30b, and then subjected to adjustment, and thereafter they are stored in the memory 37.

Thereafter, the selector SEL sequentially drives the strain gages G2 to Gn of the second sensor pattern CDB and the strain gages G2 to Gn of the third sensor pattern CDD, and sequentially obtains detection signals Rxa2 to Rxan, Rxb2 to Rxbn, Rxc2 to Rxcn, and Rxd2 to Rxdn of the strain gages G2 to Gn. The obtained detection signals are sequentially sent to the analog front end 30 to be subjected to difference detection and then adjustment, and thereafter they are stored in the memory 37.

As described above, the analog front end 30 sequentially reads the detection signals Rxa1 to Rxan and Rxb1 to Rxbn and the detection signals Rxc1 to Rxcn and Rxd1 to Rxdn sent thereto and converts the detection signals into voltage signals by the readout circuit 31, and further converts the voltage signals into digital data (Data) by the AD converter 32 and the digital filter 33. Further, the analog front end 30 detects differences between the detection signals Rxa0 to Rxan and Rxb0 to Rxbn and differences between the detection signals Rxc0 to Rxcn and Rxd0 to Rxdn by the difference detecting circuits 30a and 30b. The detected difference data is sequentially stored in the memory 37. At a time point that scanning for one frame period is completed, the analog front end 30 reads the difference data for one frame from the memory 37, and outputs the difference data to the host controller 38. The host controller 38 calculates the curved surface form of the surface 50a of the subject 50 on the basis of the sent data.

Description in the following will be made of a method of calculating the curved surface form or the radius of curvature in an example.

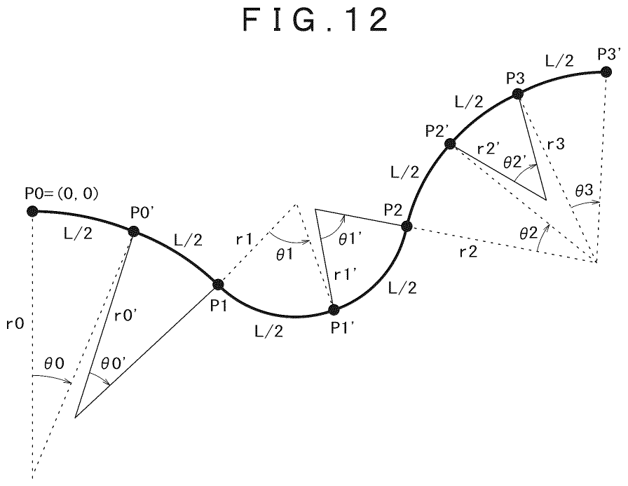

FIG. 12 is a diagram of assistance in explaining the curved surface form obtained by plotting the radius of curvature and curved surface coordinates calculated on the basis of the detection values of the strain gages GA and GD and the detection values of the strain gages GB and GC at the positions of the plurality of strain gages G0 to Gn (n=0 to 3 as an example in FIG. 12) of the strain gage sensor device 10. Here, the strain gages GA and GD located on the outsides are opposed to each other in the radial direction (thickness direction of the substrate), and are curved with mutually different radii of curvature. In addition, the strain gages GB and GC located on the inside are opposed to each other in the radial direction (thickness direction of the substrate), and are curved with mutually different radii of curvature.

In equations to be illustrated in the following, 3d denotes the thickness of the substrate, θn and θn′ denote a bending angle, rn and rn′ denote the radius of curvature of the neutral plane N, k denotes a gage factor, R0 and R0′ denote a strain gage reference resistance (initial resistance value), and ΔR0 and ΔR0′ denote a change in strain gage resistance (resistance value change amount). In addition, the following calculations are performed by the host controller 38, for example.

Description will first be made of a case of calculating the radius of curvature on the basis of the detection values of the strain gages GA and GD.

Supposing that the length of the strain gages at the neutral plane N of the substrate 11 is an initial length of the strain gages, the strain gage GA on the outside of the middle is deformed by being curved such that the length thereof in the longitudinal direction X is lengthened or shortened, and in contrast to the strain gage GA, the strain gage GD on the inside of the middle is deformed by being curved such that the length thereof in the longitudinal direction X is shortened or lengthened. Here, as an example, consideration will be given to a case where as illustrated in FIG. 10, the strain gage GA in the outermost layer is deformed by being curved into a state in which the length thereof in the longitudinal direction X is lengthened, and the strain gage GD in the innermost layer is deformed by being curved into a state in which the length thereof in the longitudinal direction X is shortened.

Letting R0 be an initial resistance value before the deformation of the strain gages GA and GD, letting VA be a potential difference across the strain gage GA (difference between a voltage value at one end of the gage and a voltage value at another end thereof) after the deformation, letting VD be a potential difference across the strain gage GD after the deformation, letting ΔR0 be changes in resistance of the strain gages, and letting I be a current flowing through each of the strain gages GA and GD, the potential difference VA of the strain gage GA and the potential difference VD of the strain gage GD are expressed as follows.

$$VA = ( R0 + Δ R 0 ) \times I$$

$$VD = ( R 0 - Δ R 0 ) \times I$$

Relation between the potential differences across the respective strain gages is expressed in the following Equation by using the changes in strain gage resistance.

$$( VD / VA ) = ( R 0 - Δ R 0 ) / ( R 0 + Δ R 0 )$$

From the above equation, a rate of change in strain gage resistance is calculated by the following Equation.

$$( Δ R 0 / R 0 ) = ( VD - VA ) / ( VD + VA )$$

From the above-described relational equation, a calculation equation for the radius of curvature rn of the neutral plane N is expressed as follows.

$$rn = ( 3 kd / 2 ) \times ( R 0 / Δ R 0 )$$

Description will next be made of a case of calculating the radius of curvature on the basis of the detection values of the strain gages GB and GC. As illustrated in FIG. 10, supposing that the length of the strain gages at the neutral plane N of the substrate 11 is an initial length of the strain gages, the strain gage GB on the outside of the middle is deformed by being curved such that the length thereof in the longitudinal direction X is lengthened or shortened, and in contrast to the strain gage GB, the strain gage GC on the inside of the middle is deformed by being curved such that the length thereof in the longitudinal direction X is shortened or lengthened. Here, as an example, consideration will be given to a case where as illustrated in FIG. 10, the strain gage GB on the outside of the middle is deformed by being curved into a state in which the length thereof in the longitudinal direction X is lengthened, and the strain gage GC on the inside of the middle is deformed by being curved into a state in which the length thereof in the longitudinal direction X is shortened.

Letting R0′ be an initial resistance value before the deformation of the strain gages GB and GC, letting VB be a potential difference across the strain gage GB (difference between a voltage value at one end of the gage and a voltage value at another end thereof) after the deformation, letting VC be a potential difference across the strain gage GC after the deformation, letting ΔR0′ be changes in resistance of the strain gages, and letting I′ be a current flowing through each of the strain gages GB and GC, the potential difference VB of the strain gage GB and the potential difference VC of the strain gage GC are expressed as follows.

$$VB = ( R {0}^{′} + Δ R {0}^{′} ) \times {I}^{′}$$

$$VC = ( R {0}^{′} + Δ R {0}^{′} ) \times {I}^{′}$$

Relation between the potential differences across the respective strain gages is expressed in the following Equation by using the changes in strain gage resistance.

$$( VC / VB ) = ( R {0}^{′} - Δ R {0}^{′} ) / ( R {0}^{′} + Δ R {0}^{′} )$$

From the above equation, a rate of change in strain gage resistance is calculated by the following Equation.

$$( Δ R {0}^{′} / R {0}^{′} ) = ( VC - VB ) / ( VC + VB )$$

From the above-described relational equation, a calculation equation for the radius of curvature rn′ of the neutral plane N is expressed as follows.

$${rn}^{′} = ( kd / 2 ) \times ( R {0}^{′} / Δ R {0}^{′} )$$

Referring to FIG. 12, suppose that the radii of curvature obtained from the detection data of the outer circumferential sensors (GA and GD) at the positions of the strain gages G0 to Gn (n=0 to 3 in FIG. 12) are r0 to r3, and suppose that the radii of curvature obtained from the detection data of the inner circumferential sensors (GB and GC) at the positions of the strain gages G0 to Gn (n=0 to 3 in FIG. 12) are r0′ to r3′. In this case, an arc between curved surface coordinates Pn and curved surface coordinates Pn′ and an arc between the curved surface coordinates Pn′ and curved surface coordinates Pn+1 are the arrangement interval L/2 (see FIG. 1) of the gage elements. Thus, the bending angles θn and θn′ are θn=L/2rn and θn′=L/2rn′ (n=0 to 3). Hence, the curved surface coordinates Pn and Pn′ can be calculated from the radii of curvature rn and rn′ and the bending angles θn and θn′.

The host controller 38 can obtain curved surface coordinates P0 (=(0, 0)) at a starting point (origin) as the position of the outer circumferential sensors (GA and GD) of the strain gages G0 from the radius of curvature r0. Next, the host controller 38 can obtain curved surface coordinates P0′ as the position of the inner circumferential sensors (GB and GC) of the strain gages G0 from the radius of curvature r0 and a bending angle θ0. Next, the host controller 38 obtains curved surface coordinates P1 as the position of the outer circumferential sensors (GA and GD) of the next strain gages G1 on the basis of the radius of curvature r0′ and a bending angle θ0′ calculated on the basis of a result of measurement by the inner circumferential sensors (GB and GC) of the strain gages G0. By sequentially performing such calculation, the host controller 38 can obtain the positions of the respective strain gages G0 to G3 (curved surface coordinates P0′, P1, P1′, P2, P2′, P3, and P3′ as viewed from a side with the curved surface coordinates P0 set as an origin).

As described earlier, an interval (distance) between P0 and P0′, an interval between P′0 and P1, and the like are L/2. Here, L is the arrangement interval of the gage elements G0 to Gn of each strain gage (CDA, CDB, CDC, and CDD) in the first strain gage elements G0 to Gn of the first strain gage CDA, the second strain gage elements G0 to Gn of the second strain gage CDB, the third strain gage elements G0 to Gn of the third strain gage CDC, and the fourth strain gage elements G0 to Gn of the fourth strain gage CDD. L/2 is an amount of shift in the length direction X of the substrate 11 (44 and 22) between the first strain gage elements G0 to Gn of the first strain gage CDA and the second strain gage elements G0 to Gn of the second strain gage CDB as viewed in plan or an amount of shift in the length direction X of the substrate 11 (44 and 22) between the third strain gage elements G0 to Gn of the third strain gage CDC and the fourth strain gage elements G0 to Gn of the fourth strain gage CDD as viewed in plan. That is, the strain gage sensor device 10 can be regarded as a strain gage sensor device in which gage elements are arranged in a row along the longitudinal direction X at intervals of L/2 as viewed in plan from the direction perpendicular to the top surface of the substrate 11. Thus, the shape of the surface 50a of the subject 50 as a measurement target object can be identified accurately by the strain gage sensor device 10 in which the arrangement intervals between the gage elements are reduced to L/2 as compared with the arrangement intervals L between gage elements adjacent to each other.

As described above, the strain gage sensor device 10 can detect the curved surface form of the whole of the surface 50a of the subject 50 by sequentially calculating radii of curvature at a plurality of positions of the surface 50a of the subject 50.

Description will next be made of a modification related to the power supply potential applied to the sensor patterns CDA, CDB, CDC, and CDD including strain gages.

In a case where the strain gage GB, the strain gage GC, the strain gage GA, and the strain gage GD of the strain gage sensor device 10 are formed with the same material and the same resistance value, strain amounts (ε1) of the strain gages GA and GD on the outside that are distant from the neutral plane N are large as compared with strain amounts (ε2) of the strain gages GB and GC on the inside that are close to the neutral plane N (ε1>ε2). Therefore, the power supply voltage applied to the strain gages GA and GD on the outside may be decreased as compared with the power supply voltage applied to the strain gages GB and GC on the inside.

That is, a series connection is established between the second strain gage CDB and the third strain gage CDC such that one corresponding second strain gage element GB and one corresponding third strain gage element GC are connected in series with each other. One end of the series connection is connected to the first reference potential (for example, the ground potential: 0 V). Another end of the series connection is connected to the second reference potential (for example, the power supply potential: +nV) higher than the first reference potential. Similarly, a series connection is established between the first strain gage CDA and the fourth strain gage CDD such that one corresponding first strain gage element GA and one corresponding fourth strain gage element GD are connected in series with each other. One end of the series connection is connected to the first reference potential (for example, the ground potential: 0 V). Another end of the series connection is connected to a third reference potential (for example, a power supply potential: +mV, +nV>+mV>0 V) higher than the first reference potential and lower than the second reference potential.

Alternatively, a driving voltage value (DV1) between one end and another end of the one corresponding second strain gage element GB and the one corresponding third strain gage element GC connected in series with each other is set high as compared with a driving voltage value (DV2) between one end and another end of the one corresponding first strain gage element GA and the one corresponding fourth strain gage element GD connected in series with each other (DV1>DV2). It is thereby possible to detect the curved shape of the surface of the measurement target with high accuracy by the strain gage sensor device 10 as one detecting device, and reduce power consumption of the strain gage sensor device 10.

It is to be noted that while an embodiment of the present disclosure has been described, the present embodiment is presented as an example, and is not intended to limit the scope of the disclosure. New embodiments can be carried out in various other modes, and various omissions, replacements, and changes can be made without departing from the spirit of the present disclosure. The embodiments and modifications thereof are included in the scope and spirit of the present disclosure, and are included in the present disclosure described in claims and the equivalent scope thereof.

All of configurations that can be implemented by those skilled in the art by making design changes as appropriate on the basis of each configuration described above as an embodiment of the present disclosure also belong to the scope of the present disclosure as long as the configurations incorporate the spirit of the present disclosure.

For example, the number of layers of the sensor patterns in the strain gage sensor device, that is, the number of layers of the strain gages is not limited to 4 (amount of shift is (½)L), but may be 6 (in this case, the amount of shift can be set to be (⅓)L), 8 (in this case, the amount of shift can be set to be (¼)L), 10 (in this case, the amount of shift can be set to be (⅕)L), or more. The number of strain gages arranged in a sensor pattern of a sensor sheet is not limited to that of the embodiment described above, but can be selected arbitrarily. The constituent material, dimensions, and shape of the sensor sheets are not limited to those of the embodiment described above, but can be changed as appropriate. The connection lines coupling the power supply lines to the ground lines are not limited to plated through holes, but may be constituted by wiring within the selector SEL.

What is claimed is:

1. A detecting device comprising:
a band-shaped flexible substrate;
a first strain gage provided in the substrate, and including a plurality of first strain gage elements provided in a form of a row at predetermined intervals in a length direction of the substrate;
a second strain gage provided in the substrate, and including a plurality of second strain gage elements provided in a form of a row at predetermined intervals in the length direction of the substrate;
a third strain gage provided in the substrate, and including a plurality of third strain gage elements provided in a form of a row at predetermined intervals in the length direction of the substrate;
a fourth strain gage provided in the substrate, and including a plurality of fourth strain gage elements provided in a form of a row at predetermined intervals in the length direction of the substrate; and
a detecting circuit connected to each of the first to fourth strain gage elements,
each of the first to fourth strain gages being disposed via an insulating layer in the substrate such that an extending direction of the first to fourth strain gages is along the length direction of the substrate,
the first to fourth strain gages being laminated in this order in a thickness direction of the substrate such that the extending direction of the first to fourth strain gages is a same direction,
the second strain gage elements and the third strain gage elements being arranged symmetrically from a position of a center in the thickness direction of the substrate, and being superposed on each other as viewed in plan,
the first strain gage elements and the fourth strain gage elements being arranged symmetrically from the position of the center in the thickness direction of the substrate, and being superposed on each other as viewed in plan,
the first strain gage elements and the second strain gage elements being shifted from each other in the length direction of the substrate as viewed in plan,
the third strain gage elements and the fourth strain gage elements being shifted from each other in the length direction of the substrate as viewed in plan.

2. The detecting device according to claim 1, wherein
for each of the first to fourth strain gage elements, a plurality of corresponding strain gage elements are arranged at equal intervals in the length direction of the substrate,
an amount of shift between the first strain gage elements and the second strain gage elements as viewed in plan is ½ of an arrangement interval between strain gage elements adjacent to each other, and
an amount of shift between the third strain gage elements and the fourth strain gage elements as viewed in plan is ½ of the arrangement interval between the strain gage elements adjacent to each other.

3. The detecting device according to claim 1, wherein
the first strain gage is disposed in a first sensor substrate,
the second strain gage is disposed in a second sensor substrate,
the third strain gage is disposed in a third sensor substrate,
the fourth strain gage is disposed in a fourth sensor substrate, and
the second sensor substrate and the third sensor substrate are arranged so as to be shifted from the first sensor substrate and the fourth sensor substrate in the length direction of the substrate.

4. The detecting device according to claim 1, wherein
a series connection is established between the second strain gage and the third strain gage such that one corresponding second strain gage element and one corresponding third strain gage element are connected in series with each other, one end of the series connection is connected to a first reference potential, and another end of the series connection is connected to a second reference potential higher than the first reference potential, and
a series connection is established between the first strain gage and the fourth strain gage such that one corresponding first strain gage element and one corresponding fourth strain gage element are connected in series with each other, one end of the series connection is connected to the first reference potential, and another end of the series connection is connected to the second reference potential.

5. The detecting device according to claim 1, wherein
in a state in which there is no strain, resistance values of the second strain gage elements and resistance values of the third strain gage elements are same, and resistance values of the first strain gage elements and resistance values of the fourth strain gage elements are same.

6. The detecting device according to claim 5, wherein
in a state in which there is strain, the resistance values of the second strain gage elements are different from the resistance values of the third strain gage elements, and the resistance values of the first strain gage elements are different from the resistance values of the fourth strain gage elements.

7. The detecting device according to claim 6, wherein
the detecting circuit is configured to
obtain a first radius of curvature of the substrate on a basis of the resistance values of the second strain gage elements and the resistance values of the third strain gage elements,
obtain a second radius of curvature of the substrate on a basis of the resistance values of the first strain gage elements and the resistance values of the fourth strain gage elements, and
identify a shape of an object on a basis of the first radius of curvature and the second radius of curvature.
